(19) United States
(12) Patent Application Publication
(10) Pub. No.: US 2008/0216049 A1
(43) Pub. Date: Sep. 4, 2008

(54) Software Component-Based Architecture for Applications with Execution Platform Affording Acces to the Metaprogram Level

(75) Inventors: Philippe Fournies, Clamart (FR); Emmanuel Grivot, Cachan (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 11/996,926

(22) PCT Filed: Jul. 26, 2006
(86) PCT No.: PCT/EP06/64679

§ 371 Date: Jan. 25, 2008

(30) Foreign Application Priority Data
Jul. 26, 2005 (FR) 05 07950

(51) Int. Cl. G06F 9/44

(52) U.S. Cl. 717/100

(57) ABSTRACT

The present invention pertains to a software component-based architecture for applications with execution platform affording access to the metaprogram level, and in particular for developing and executing man-machine interfaces, and it is characterized in that it is an architecture with components explicitly defining all the characteristics of the components, practically without involving the code defining these components, managing the components during their execution, and providing them with technical services, and that it comprises a generic container accommodating on the one hand components whose definition ensues from the specifications of the provisions of the application to be carried out and depends on the domain of use of the application, this container accommodating on the other hand technical services provided.

### CROSS-REFERENCE TO RELATED APPLICATIONS

The present Application is based on International Application No. PCT/EP2006/064679, filed on Jul. 26, 2006, which in turn corresponds to French Application No. 05 07950 filed on Jul. 26, 2005, and priority is hereby claimed under 35 USC §119 based on these applications. Each of these applications are hereby incorporated by reference in their entirety into the present application.

### FIELD OF THE INVENTION

The present invention pertains to a software component-based architecture for applications with execution platform affording access to the metaprogram level, and in particular for developing and executing man-machine interfaces (MMI or HCI: “Human Computer Interface”).

### BACKGROUND OF THE INVENTION

The development of MMI applications encounters problems of different kinds:
functional problems (which address the client's operational requirements)
technical problems (which address the client's nonfunctional requirements)

The developer must provide solutions to all these problems. These solutions are usually interleaved. This interleaving does not allow easy maintenance, upgrading and reutilization. Functional upgrades requested by the client are more difficult to take into account. It is also very difficult to capitalize technical solutions separately from the functionalities (specific to each client).

The developer cannot concentrate on the added value of the development constituted by the functionalities for the client. Moreover, the developer must structure his application by choosing an architecture.

A component-based architecture proposes a decomposition into elements (components) that are weakly coupled (with the minimum possible interdependance between them). This component-based architecture is regular and is applicable to the application as a whole. These components being weakly coupled, their maintenance, their upgrading and their reutilization are easier.

These components having a regular structure, they are managed in a generic manner by a components manager (a container). This container furnishes technical solutions to the nonfunctional problems of the application. These technical solutions are capitalized separately from the functionalities and available for all the MMI applications. The developer can then more easily concentrate on the functional requirements, independently of the technical requirements.

Today, component-based architectures are proposed by standards (JavaBeans, Enterprise JavaBeans—EJB, CORBA Component Model—CCM) and COTS (Component Object Model—COM, SpringFramework, etc.). Within the framework of a multi-level architecture (FIG. 1), these architectures concentrate on the business level, few relate to the presentation level.

The presentation level can take two different forms:
heavyweight clients (MMI application in its own right to be deployed on the client station before use)
lightweight clients (only a Web browser is deployed on the client station).

Component-based architectures are proposed essentially for lightweight clients (Java Server Page—JSP, Active Server Page—ASP, etc.).

For heavyweight clients, the known component-based architectures propose only a subset of the entirety of characteristics necessary for the complete definition of a component, and which constitute a component model. The component model within the sense of the present invention must comprise at least the following definitions:
explicit definition of the services rendered and used by the component
explicit definition of the events produced and consumed by the component
explicit definition of the parameters of the component
explicit definition of the type of the component.

These characteristics, if they were all present in an architecture, would make it possible to clearly separate the interface of the component from its implementation. They would therefore make it possible to provide several implementations for one and the same interface.

Moreover, the majority of the known component models impose a particular form: these component models are very intrusive. The analysis classes (resulting from the analysis of the functional specifications of the application) must be profoundly transformed so as to conform to the mold of the component-based architecture of the standard or COTS. The current objective of the computer industry is to achieve total transparency for component models: the analysis classes would then not be transformed so as to be accommodated by the container.

Additionally, the current component architectures propose only a subset of the necessary technical capabilities:
the services are solely in synchronous mode,
the events are solely in asynchronous “push” mode,
the data of the services and events are solely defined by values (by copying) or by reference on the basis of the deployment (the data are defined by value solely in the case of network remote access).

The necessary technical capabilities are present when:
the services can be used in a synchronous or asynchronous manner,
the events can be published in “push” or in “pull” mode, in a synchronous or asynchronous manner,
the data of the services and events are transmitted by value or by reference independently of the deployment and of the network access.

Architectures whose JAC container accommodates business classes and technical components are known from the following documents extracted from the Internet: the document by CARSIQUE, JULIEN of 14 Nov. 2002, pages 1 to 9, “JAC, Java Aspects Components—Serveur d'applications Java Open-Source (LGPL) basé sur la Programmation Orientée Aspect” and the document by PAWLAK, RENAUD ET AL of 5 Dec. 2002, pages 1-22 “JAC, An Aspect-Based Distribution Dynamic Framework”. As regards business classes, JAC, just like the known architectures EJB or CCM, remain at the class level, while their components are not replaceable without changing the type of these components.

### SUMMARY OF THE INVENTION

One object of the present invention is a software component-based architecture for applications with execution platform affording access to the metaprogram level, and in particular for developing and executing man-machine interfaces within the framework of heavyweight clients, which is complete and transparent, and its subject is also a man-machine interface comprising such an architecture.

Another object of the present invention is a method of placing software components in communication for an application with execution platform affording access to the metaprogram level, namely an application implementing a programming language which provides an object definition of itself, in an architecture of the aforesaid type, method producing practically no intrusion into the code of the components, the technical constraints being reduced to their simplest expression.

The component-based architecture in accordance with the invention is a component-based architecture explicitly defining all the characteristics of the components, practically without involving the code defining these components, managing the components during their execution, and providing them with technical services, and it comprises a generic container accommodating on the one hand components whose definition ensues from the specifications of the provisions of the application to be carried out and depends on the domain of use of the application, this container accommodating on the other hand technical services provided.

The method of the invention is performed by container that automatically, determines on execution the characteristics of the components and the description of the technical services provided by interrogating via the metaprogram the components and the services provided.

According to another aspect of the method of the invention, the technical services provided are made available to the components by a directly executable code segment generated by the container. In an advantageous manner, the code segment ensures the join between any two components.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and it several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, already mentioned above, is a simplified block diagram of a software component-based architecture for developing and executing man-machine interfaces either within the framework of heavyweight clients or lightweight clients, to which architecture the invention may be applied,

FIG. 2 is a simplified block diagram of the component-based architecture in accordance with the invention, together with the container, the application components accommodated, and the technical services provided by the container and available for all the components,

FIG. 3 is a block diagram explaining operating details of the architecture of FIG. 2,

FIGS. 4 to 8 are diagrams of exemplary component implementations, in accordance with the invention.

### DETAILED DESCRIPTION OF THE INVENTION

The present invention is described in detail below with reference to a man-machine interface, but it is of course understood that it is not limited to this example alone, and that it can be implemented for all other applications comprising an execution platform allowing access to the metaprogram level, that is to say applications implementing a programming language which provides an object definition of itself.

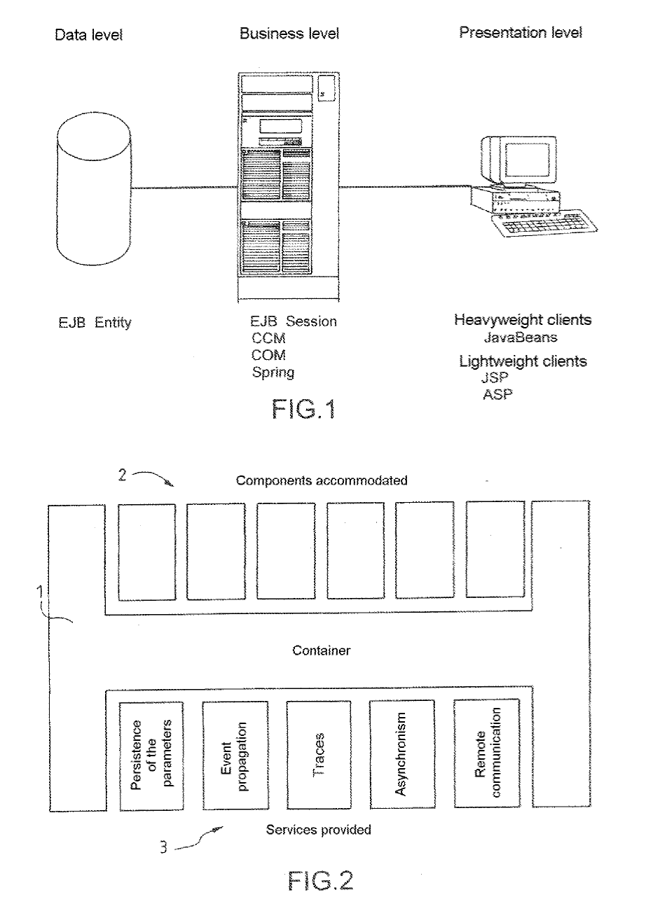

Represented schematically in FIG. 1 are the three main levels of a software component-based architecture for developing and executing man-machine interfaces. These three levels are: the data level (implementing a standard such as EJB), the business level (that can implement standards such as EJB session, CCM, COM, Spring) and the presentation level, which is a workstation. If this station is that of heavyweight clients, it generally operates under JavaBeans, while for lightweight clients, it can operate under JSP or ASP for example.

The software component-based architecture represented in FIG. 2 essentially comprises a generic container 1 accommodating on the one hand components 2 whose definition ensues from the specifications of the provisions of the application to be carried out and depends on the domain of use of this application. The container 1 accommodates on the other hand services provided such as those cited below.

The container is in charge of managing the execution life cycle of the components. It activates them, deletes them, places them in intercommunication, and connects them to the technical services which they require, for example as a function of the desired service quality, which may be changeable.

The components accommodated are the components developed within the framework of a specific application. They express in a manner comprehensible to the container the nature of the technical services from which they wish to benefit. The container interprets these expressions of requirements and calls the technical services desired in place of these components, for their benefit, and puts them in touch with the requesting components.

The technical services are components used by the container to take charge of the nonfunctional capabilities, such as:
the persistence of the parameters of the components
the propagation of events between components (according to the “push” or “pull” modes)
the traces of the inputs/outputs of the components
the asynchronism of the inputs/outputs of the components
the remote communication (network) between the components

The architecture of the invention defines the principles of development of an application based on components by stipulating components that is compatible with a process centered on the UML model (“model driven”).

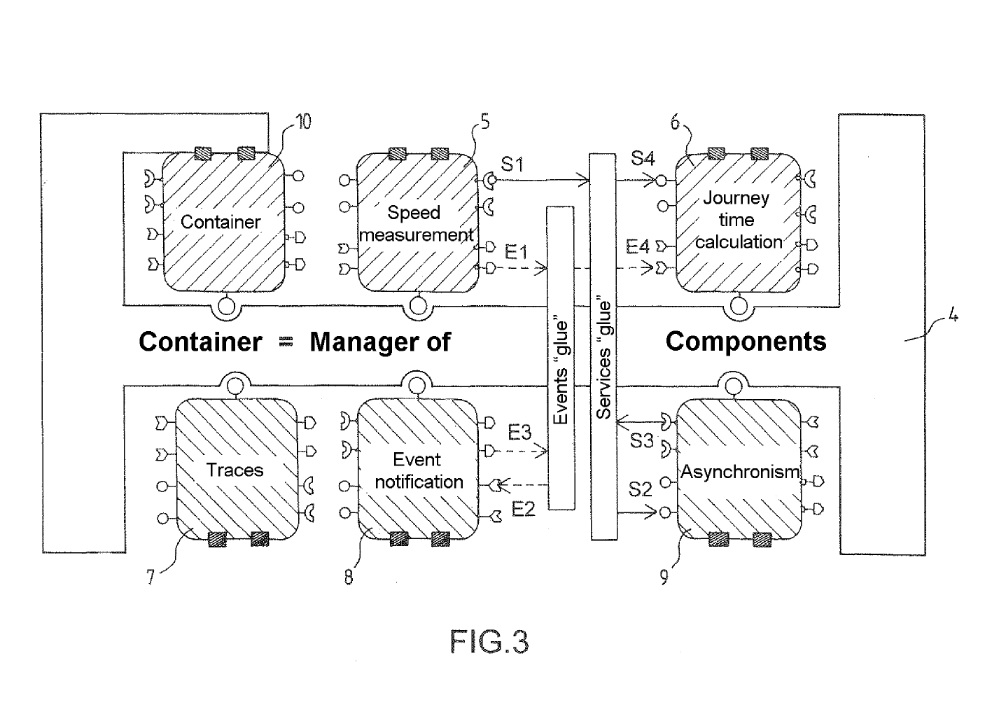

In the diagram of FIG. 3, which partially represents an interface of a vehicle control device, a container 4 accommodates on the one hand application components such as the components 5 and 6 (respectively a speed measurement component and a journey time calculation component, for this example), and technical services 7, 8 and 9 (respectively the traces of the inputs/outputs of the components implemented, the notification of events and the management of asynchronism). Furthermore, the container being considered to be a component just as all the elements that it accommodates, it comprises an extension 10 which is represented like the other components and which behaves like them. It follows from this that all this architecture is homogeneous and consists of components intercommunicating in the same manner, as explained below.

It is assumed that the component 5 wishes to communicate with the technical service 10. For this purpose, it dispatches an event request to the container 4. The container adds to this request a directly executable code segment (code that can be produced solely by the container and dubbed “glue”) ensuring the technical join between the requesting component and the requested component, whose content is dependent on the requirement expressed by the requester. The request, accompanied by this code, is transmitted to the requested component (the technical service 10 in the present case), which readies itself to communicate. Thereafter, the dialog continues between the components 5 and 10 each time via the container 4 until its completion. The same process is implemented each time between two components attached to the container 4, whatever their nature (components as such, like the components 5 and 6, or else technical services).

The present invention uses the reflection mechanisms offered by the Java platform to describe the components without deforming them (practically no intrusion into the code of the components, the technical constraints are reduced to their simplest expression). These reflection mechanisms allow the program to examine itself and to manipulate the elements of the language during its execution, with the aid of an object representation of itself. The use of programming elements such as tag interfaces or annotations makes it possible to describe the characteristics of these components with no downside (in particular, no additional code in the component related to the use of these tag interfaces nor to the annotations).

The description of the characteristics of a component is done with the aid of the following elements of the component model:
Type of the component: “ComponentType” interface or meta-data.
Services of the component: “ComponentServices” interface or meta-data.
Events of the component: “ComponentEvents” interface or meta-data.
Parametrization of the component: “ComponentParameters” interface or meta-data.
Data of the component: “ComponentDataServices” interface or meta-data for access to the data, “ComponentDataEvents” interface or meta-data for events related to the data.

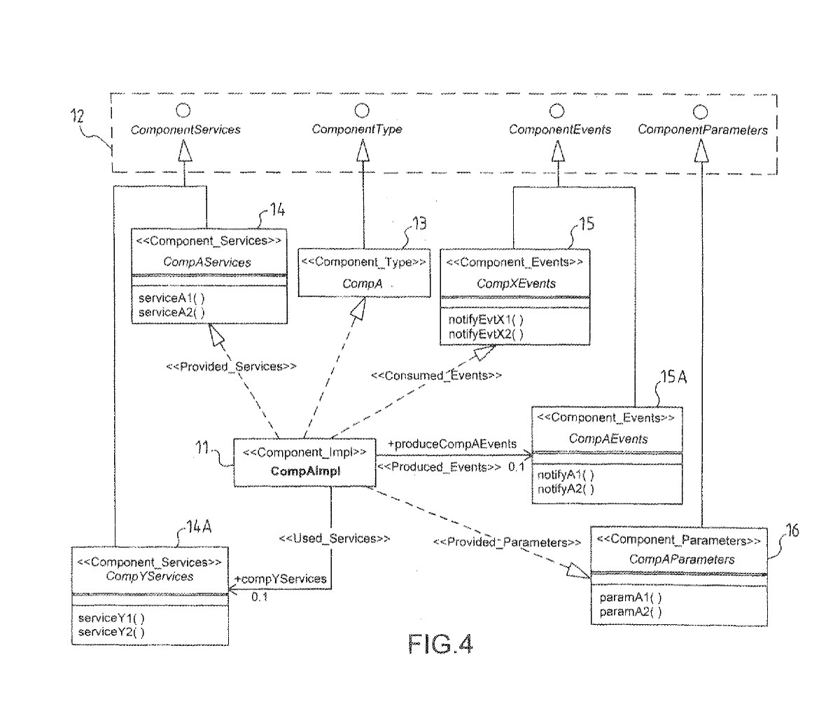

In FIG. 4, which illustrates an exemplary description of a component 11 (“component impl”) made before its use in an application, the first four interfaces 12 (the component model) are represented in a first row. Thereafter come the interfaces and the classes of the component defined for the application considered: type of component 13, services of the component 14 (services provided) and 14A (services used), events of the component 15 (events used) and 15A (events produced), parameters of the component 16 (parameters provided).

In the example of FIG. 5, the services and the events related to the data are represented by the use of meta-data (Java annotations). The component 17 is described by:
technical services provided 18 defined by data relating to the data of the component and to which Java annotations 18A are attached,
the type of component 19, to which the Java annotation 19A is attached,
events produced defined by events data 20, to which Java annotations 20A are attached.

According to the invention, the container ensures the management of the components whose description it has.

In particular, it manages the life cycle of the components, namely:
Creation of the instances of the components.
Activation and deactivation of the instances of the components.
Deletion of the instances of the components.

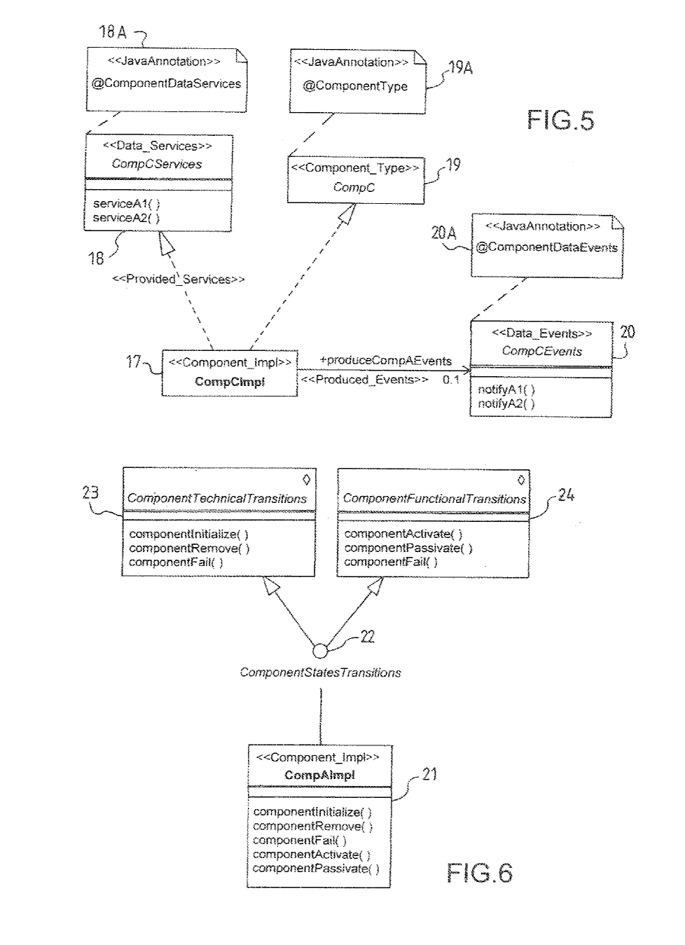

The components which are involved through their life cycle must write additional code so as to take over control in the phases in which they are involved. In FIG. 6, the component 21 is involved in all the phases of the life cycle of its life cycle: initialization, deletion, fault, activation, passivation. The transitions 22 between these various states are classed into two categories: transitions 23 termed technical (initialization, deletion and fault) and transitions 24 termed functional (activation, passivation and fault).

On execution of the application, the container connects the components of the application as a function of their requirements:
Plugging of the provided services into the used services.
Plugging of the produced events into the consumed events.
Plugging of the provided parameters into the used parameters.

The container utilizes the description of the requested technical services to interconnect the components.

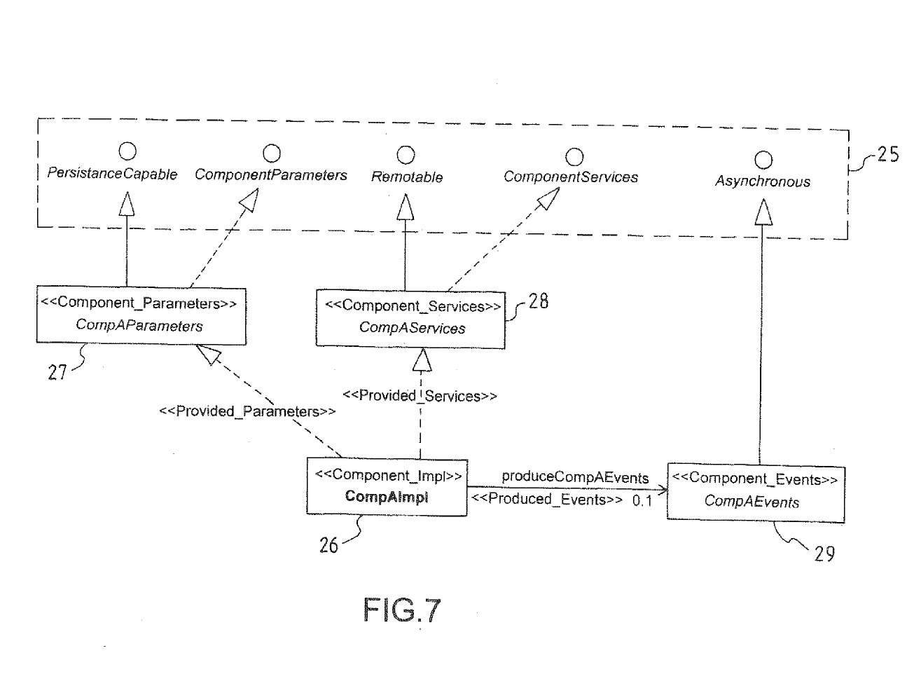

FIG. 7 explains an exemplary description of the technical services requested by a component. Represented therein is a component model interface 25 comprising a few examples of technical services that may be requested by a component 26. The component 26 is described in the example by:
The parameters 27 of the component (CompAParameters) are declared persistent (tagging by the interface “PersistanceCapable” or the corresponding meta-data).
The services 28 of the component (CompAServices) are declared as being accessible remotely (tagging by the interface “Remotable” or the corresponding meta-data).
The events 29 of the component (CompAEvents) are published asynchronously (tagging by the interface “Asynchronous” or the corresponding meta-data).

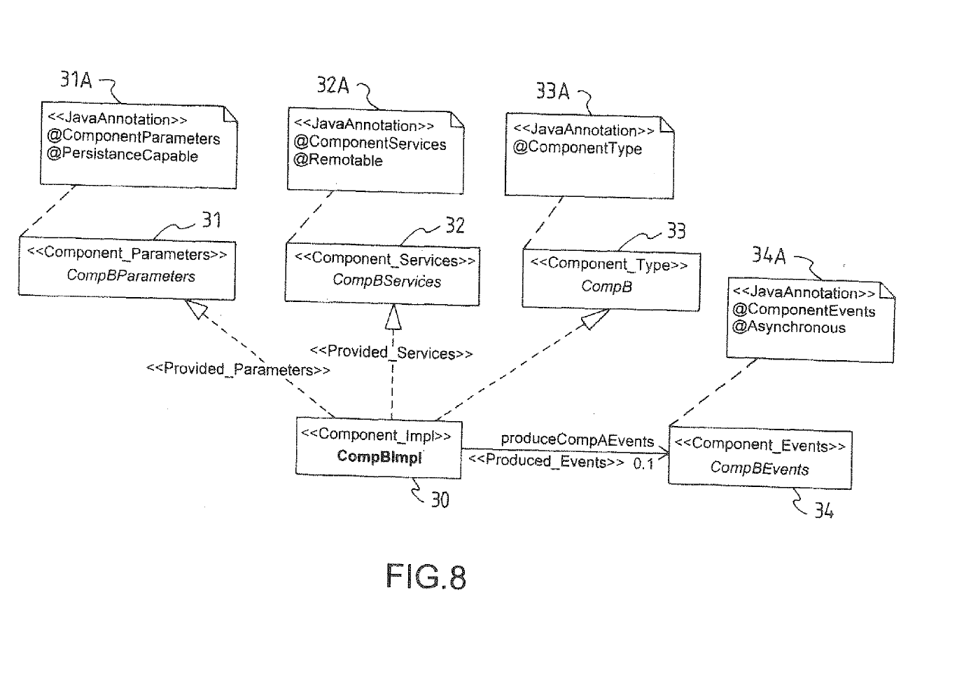

In all cases, the tag interfaces can be replaced with the meta-data mechanism proposed by the programming language and platform. In the case of the Java language, these meta-data are transcribed by annotations. This gives the diagram of FIG. 8, in which the component 30 is described in the example by:
component parameters 31, to which the Java annotation 31A is attached,
component services 32, to which the Java annotation 32A is attached,
a component type description 33, to which the Java annotation 33A is attached,
a produced events description 34, to which the Java annotation is attached

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A software component-based architecture for an application with execution platform affording access to the metaprogram level, wherein an application implementing a programming language provides an object definition of itself, wherein this architecture is an architecture with components explicitly defining all the characteristics of the components, substantially without involving the code defining these components, managing the components during their execution, and providing the components with technical services, and wherein this architecture comprises a generic container accommodating components whose definition ensues from the specifications of the provisions of the application to be carried out and depends on the domain of use of the application, this container accommodating technical services provided.

2. The architecture as claimed in claim 1, wherein the services provided are at least one of the following services: the persistence of the parameters of the components, the propagation of events between components, according to the “push” or “pull” modes, the traces of the inputs/outputs of the components, the asynchronism of the inputs/outputs of the components, remote communication between the components.

3. A method of placing software components in communication for an application with execution platform affording access to the metaprogram level, in an architecture as claimed in claim 1, wherein the container automatically determines on execution of the program for managing the components of the architecture the characteristics of the components and the description of the technical services provided by interrogating via the metaprogram the components and the services provided.

4. The method as claimed in claim 3, wherein the technical services provided are made available to the components by a directly executable code segment generated by the container.

5. The method as claimed in claim 4, wherein the code segment ensures the join between any two components

6. A man-machine interface, implemented by an execution platform affording access to the metaprogram level, namely an application implementing a programming language which provides an object definition of itself, wherein the man-machine comprises an architecture as claimed in claim 1.
